(19) United States
(12) Patent Application Publication
(10) Pub. No.: US 2022/0358565 A1
(43) Pub. Date: Nov. 10, 2022

(54) System And Methods For Anonymous Order Validation In Remote Transactions

(71) Applicant: Pour, Inc., Gainesville, FL (US)

(72) Inventor: Erik Christiansen, Gainesville, FL (US)

(21) Appl. No.: 17/739,112

(22) Filed: May 7, 2022

Related U.S. Application Data
(60) Provisional application No. 63/185,629, filed on May 7, 2021.

(51) Int. Cl. G06Q 30/06; G06Q 50/12

(52) U.S. Cl. CPC G06Q 30/0635; G06Q 50/12; G06Q 30/0641

(57) ABSTRACT

The present disclosure provides for systems and methods for remote transactions. The method may comprise a secure connection between an establishment and a client that provides for the client's anonymous identification while providing identifying information from the establishment. The system may comprise a secure connection and unique ID that allows for anonymous identification without sharing identifying information. A unique ID may comprise a randomly generated group of characters or unique paired identifiers such as matching color indicators for the employee and client that indicate the same order, as non-limiting examples. When the system comprises geolocation indications, a unique ID may facilitate secure connections with anonymous identification to establishments within a predetermined distance. When the system comprises a plurality of establishments, a unique ID may facilitate secure connections with client-based anonymous identification to establishments. The unique ID may provide sufficient identification to manage and manipulate associated client orders.

### CROSS-REFERENCE TO RELATED APPLICATION

This application claims priority to and the full benefit of U.S. Non-provisional Patent Application Ser. No. 63/185,629 (filed May 7, 2021, and titled “Systems and Methods for Anonymous Order Validation in Remote Transactions”), the entire contents of which are incorporated herein by reference.

### BACKGROUND

Customer service is integral to running any successful business, particularly within the food and beverage industry. Every second a customer must wait to place or receive an order can negatively impact their impression of an establishment's overall service quality. The business can also be adversely impacted as they struggle to meet demand for high-margin items. It often becomes impossible for a busy venue to effectively manage this supply-demand disequilibrium, and they become a victim of their own success.

The customer experience for ordering food and drinks often involves waiting in line to place an order and make payment. At more unstructured establishments, like a bar, there may be significant maneuvering required to even get to that step. The customer then must wait for their order to be prepared. If the establishment is particularly busy and loud, the customer has to make a concerted effort to know when their order is ready. In crowded establishments, it is likely that some customers will have the same name, leading to confusion and the possibility of receiving someone else's order. The ordering process overall often proves incredibly frustrating as customers are forced through the steps of navigating a busy crowd to place an order, waiting for their order to be prepared, making payment, then potentially having to return at a busier time later in the night to close a tab. This process is also costly for the venue, which has to carefully manage order details and customer tabs to mitigate the risk of chargebacks from claims of invalid charges and unauthorized tip amounts.

For workers, the experience at these establishments can be feast or famine. At some points throughout the day they are cleaning the counter, restocking shelves, and taking inventory. During their busiest times, workers struggle to take and fulfill orders in a timely fashion. Taking payment adds another layer of complexity that puts a significant strain on efficiency. Balancing these various responsibilities effectively is of the utmost importance when considering an establishment's longevity and employee well-being.

Innovation through digital ordering has helped address these issues somewhat. For take-away orders, the solution is relatively straightforward, with some establishments setting up a specific place to leave orders that customers can inspect and take with minimal interaction. In the busy settings described above, however, there are still issues with the hand-off aspect of receiving an order. There may be confusion when validating someone's order, particularly when an establishment is at full capacity, with similarly-named patrons ordering at the same time.

On top of that, most solutions require each side to create some sort of profile and set up their orders native to each establishment so that each side receives the information they need (name, payment information, and so on) before they can place an order. This may be overwhelming to a customer if they have to go through this process at each establishment they frequent. Additionally, recent and emerging legislation (including California's CCPA and the European Union's GDPR) has made it more important for organizations to focus on being good stewards of their customers' data. The most effective way to do this is to avoid collecting personally-identifying information altogether.

### SUMMARY OF THE DISCLOSURE

What is needed is a system and method for anonymous order validation. Accordingly, the present disclosure provides for systems and methods for remote transactions. In some embodiments, the system may create a unique order identifier or code with varying levels of differentiation. The system may comprise at least one secure connection and at least one unique identifier or “ID” that allows for anonymous identification of at least one user without sharing identifying information. The method may comprise forming at least one secure connection between at least one computing device associated with a location or establishment and at least one computing device associated with a user or client that provides for the client's anonymous identification and also providing identifying information from the establishment.

A unique ID may comprise at least one randomly-generated character appended to a running order count and paired with additional, clear visual indicators such as a unique, matching color scheme that the employee and client can use to identify the same order, as a non-limiting example. This exemplary three-part system ensures uniqueness of order codes while visually simplifying order match-up and preserving customer anonymity. When the system comprises geolocation indications, a unique ID may facilitate secure connections with anonymous identification to establishments within a predetermined distance. When the system comprises a plurality of establishments, a unique ID may facilitate secure connections with anonymous identification to all of the establishments. The unique ID may provide sufficient identification to manage and manipulate associated client orders.

The present disclosure relates to a computer-implemented method for providing a remote transaction service, the computer-implemented method comprising generating at least one unique identifier; associating the at least one unique identifier with at least one anonymous user; presenting at least one location to associate with the at least one unique identifier; receiving a selection of the at least one location to associate with the at least one unique identifier; associating the selected at least one location with the at least one unique identifier; forming at least one secure connection between at least one server, at least one computing device associated with the at least one location, and at least one computing device associated with the at least one anonymous user; receiving a request for at least one order from the at least one anonymous user, wherein the at least one order comprises a product or service provided by the at least one location; transmitting the request for the at least one order to the at least one location; and receiving confirmation of order fulfillment from the at least one anonymous user.

In some aspects, the method may further comprise receiving electronic payment information for the at least one order from the at least one anonymous user; and processing payment for the at least one order using the electronic payment information received from the at least one anonymous user. In some embodiments, the method of claim 1, may further comprise storing information pertaining to the order fulfillment in at least one database. In some aspects, the presentation of the at least one location to the at least one anonymous user selection may be at least partially determined by geolocation.

In some implementations, the method may further comprise the presentation of the at least one location to the at least one anonymous user selection is at least partially determined by a selection of a geographical area. In some aspects, the at least one unique identifier at least partially comprises a color. In some embodiments, the at least one unique identifier may be shareable between two or more anonymous users.

In some implementations, the method may further comprise presenting an estimated time of fulfillment for the at least one order received from the at least one anonymous user. In some embodiments, the at least one anonymous user may not physically be present at the at least one location. The method may further comprise terminating the at least one secure connection between the at least one server, the at least one computing device associated with the at least one location and the at least one computing device associated with the at least one anonymous user.

In some embodiments, the at least one unique identifier may become void after the at least one secure connection between the at least one location and the anonymous user is terminated. In some aspects, the at least one unique identifier may be automatically terminated after a predetermined amount of time lapses. In some implementations, the at least one secure connection may comprise one or more access protocols.

The present disclosure relates to a system for providing a remote transaction service, comprising one or more computing devices; at least one secure connection, wherein the at least one secure connection connects to the one or more computing devices; at least one server, wherein the at least one secure connection connects the at least one server to the one or more computing devices; at least one storage database, wherein the at least one storage database comprises one or more access protocols and associated information for establishing the at least one secure connection between the one or more computing devices and the at least one server; at least one network, wherein the at least one network comprises the at least one server and the at least one storage database; wherein the one or more access protocols comprise a connection, wherein the connection allows the one or more access protocols to provide access for the at least one secure connection to connect to the at least one network, wherein the connection is configured to enable the system to generate at least one unique identifier; associate the at least one unique identifier with at least one anonymous user; present at least one location to associate with the at least one unique identifier; receive a selection of the at least one location to associate with the at least one unique identifier; associate the selected at least one location with the at least one unique identifier; form the at least one secure connection between the at least one server, at least one computing device associated with the at least one location, and at least one computing device associated with the at least one anonymous user; receive a request for at least one order from the at least one anonymous user, wherein the at least one order comprises a product or service provided by the at least one location; transmit the request for the at least one order to the at least one location; and receive confirmation of order fulfillment from the at least one anonymous user.

In some aspects, the at least one network may comprise a cloud network. In some embodiments, the at least one storage database may comprise cloud storage. In some implementations, the connection may be further configured to enable the system to receive electronic payment information for the at least one order from the at least one anonymous user; process payment for the at least one order using the electronic payment information received from the at least one anonymous user; store information pertaining to the order fulfillment in the at least one storage database; and terminate the at least one secure connection between the at least one server, the at least one computing device associated with the at least one location and the at least one computing device associated with the at least one anonymous user.

In some embodiments, the at least one unique identifier may be voided when the at least one secure connection between the at least one location and the at least one anonymous user is terminated. In some aspects, the at least one secure connection may be automatically terminated after a predetermined amount of time lapses. In some implementations, the at least one unique identifier may comprise one or more unique random variables.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary client interface, according to some embodiments of the present disclosure.

FIG. 2 illustrates an exemplary remote transaction service, according to some embodiments of the present disclosure.

FIG. 3A illustrates an exemplary client interface, according to some embodiments of the present disclosure.

FIG. 3B illustrates an exemplary client interface, according to some embodiments of the present disclosure.

FIG. 3C illustrates an exemplary client interface, according to some embodiments of the present disclosure.

FIG. 3D illustrates an exemplary client interface, according to some embodiments of the present disclosure.

FIG. 3E illustrates an exemplary client interface, according to some embodiments of the present disclosure.

FIG. 4A illustrates an exemplary client interface, according to some embodiments of the present disclosure.

FIG. 4B illustrates an exemplary client interface, according to some embodiments of the present disclosure.

FIG. 4C illustrates an exemplary client interface, according to some embodiments of the present disclosure.

FIG. 4D illustrates an exemplary client interface, according to some embodiments of the present disclosure.

FIG. 5A illustrates an exemplary employee interface, according to some embodiments of the present disclosure.

FIG. 5B illustrates an exemplary employee interface, according to some embodiments of the present disclosure.

FIG. 5C illustrates an exemplary employee interface, according to some embodiments of the present disclosure.

FIG. 6A illustrates an exemplary employee interface, according to some embodiments of the present disclosure.

FIG. 6B illustrates an exemplary employee interface, according to some embodiments of the present disclosure.

FIG. 6C illustrates an exemplary employee interface, according to some embodiments of the present disclosure.

FIG. 7A illustrates an exemplary administrative interface, according to some embodiments of the present disclosure.

FIG. 7B illustrates an exemplary administrative interface, according to some embodiments of the present disclosure.

FIG. 7C illustrates an exemplary administrative interface, according to some embodiments of the present disclosure.

FIG. 7D illustrates an exemplary administrative interface, according to some embodiments of the present disclosure.

FIG. 7E illustrates an exemplary administrative interface, according to some embodiments of the present disclosure.

FIGS. 8A-B illustrate exemplary method steps for providing a remote transaction service, according to some embodiments of the present disclosure.

### DETAILED DESCRIPTION

In the following sections, detailed descriptions of examples and methods of the disclosure will be given. The description of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Remote Transaction Service: as used herein refers to an interface that allows orders to be fulfilled for at least one user. In some embodiments, the remote transaction service may comprise an interface that may assist in facilitating transactions between at least one user or client and at least one location or establishment.
User: as used herein refers to any individual who may use the remote transaction service of the present disclosure. By way of example and not limitation, a user may comprise a clients guest, visitor, or patron of a location, business, or establishment; an employee, administrator, owner, or other worker associated with a location, business, or establishment; and the like.
Location: as used herein refers to any entity that offers one or more products or services intended to be received or utilized by one or more individuals. By way of example and not limitation, a location may comprise an establishment, business, restaurant, venue, bar, or night club.
Order: as used herein refers to a request for at least one product or service provided by a location. By way of example and not limitation, an order may comprise a food or beverage order or a request to have a drink refilled.
Secure connection: as used herein refers to at least one computer server that facilitates a connection between computing devices associated with at least two entities that limits or eliminates the use and sharing of personal information. In some embodiments, at least one user or client may use a randomly generated grouping of one or more characters or variables to establish a secure connection with a location or establishment. This grouping of variables may comprise a unique identifier that matches with an available connection port provided by the establishment. In some aspects, the secure connection may terminate, expire, or otherwise become void after the remote transaction service has been used. For example, the remote transaction service may use geolocation to detect when a client has left a location after having an order fulfilled and may dissolve the secure connection to the establishment as the client leaves.
Unique identifier, unique identification, unique code, or unique ID: as used herein refers to a randomly generated grouping of one or more characters or variables or some other randomized anonymous identifier. In some embodiments, the unique ID may at least partially comprise at least one color, wherein the at least one color may be associated with an order. In some aspects a, unique identifier may provide a clear identification for matching users or clients to their orders placed to a location or establishment. As an example, an order number may be green and as the employee delivers the order, the employee may use the green color to verify the order is delivered to the intended client. In some implementations, the unique ID may be used to establish a secure connection with an establishment. In some aspects, a unique identifier may be used to gain access to a venue by showing proof-of-purchase to the location's entry manager, such as a doorman or “bouncer”. In some aspects, a unique identifier may be associated with exclusive use of an area of an establishment by a patron or group of patrons for a specified period of time (e.g., a table reservation). In some implementations, the unique identifier may comprise a unique token stored within at least one database that allows the identifier to be associated with an order request.
Anonymous identification: as used herein refers to attributes of a user or client within the remote transaction service that comprise only non-identifying information and intentionally excludes identifying personal information such as, but not limited to, email address, physical address, name, phone number, payment information, username, or password. In some embodiments, the anonymous identification may comprise a unique ID, unique color authentication, and/or one or more randomly generated variables, as a list of non-limiting examples. In some implementations, this anonymous identification and its aforementioned attributes may be used in establishing a secure connection that is maintained only for the duration of the utilization of the remote transaction service.
Identifying information: as used herein refers to information intentionally excluded by anonymous identification. In some embodiments, the information used for anonymous identification may comprise a username, a password, establishment menus, location or establishment biographical information, or transaction service information such as, but not limited to, point of sale systems, payment verification, or associated payment accounts, as a non-limiting list. In some implementations, locations or establishments may comprise identifying information that allows the establishment to be identified by a user or client. In some aspects, a secure connection may be formed that comprises an establishment's identifying information and a client's anonymous identification, thereby allowing the client's information to remain anonymous for the duration of the secure connection.

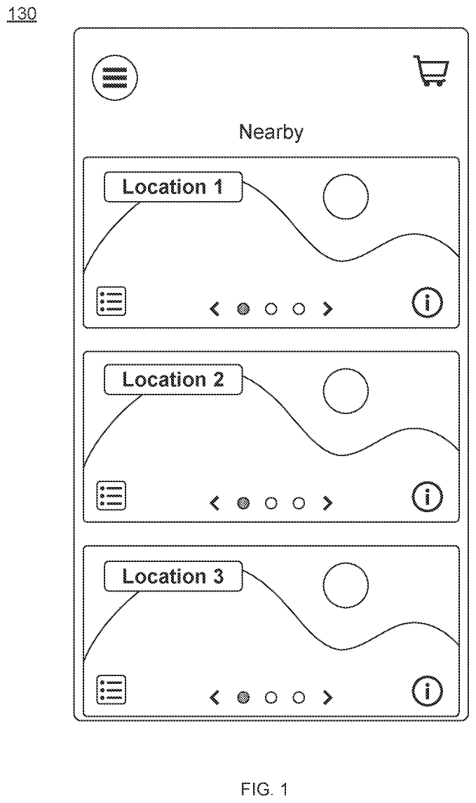

Referring now to FIG. 1, an exemplary client interface 130 is illustrated. In some aspects, a remote transaction service may comprise a plurality of interfaces 130. In some embodiments, the client interface 130 may comprise displays of nearby locations or establishments. In some implementations, the client interface 130 may comprise at least one secure connection. The secure connection may allow the client interface 130 to facilitate connections between establishments and clients using anonymous identification.

In some embodiments, the remote transaction service may comprise an interface 130, wherein local establishments may be presented to a potential client. In some implementations, the remote transaction service may be used to automate existing manual orders within an establishment.

For example, rather than an employee taking an order at a table, a client may order through the client interface 130 and the employee may deliver the order to a predetermined location after the transaction is complete. In some aspects, the client interface 130 may use color-coded unique identifiers or “IDs” to fulfill orders. In some embodiments, these non-identifying attributes of a client's secure connection may allow the client to use anonymous identification to access the interface 130. This anonymous identification may comprise non-identifying attributes that facilitate a secure connection to an establishment without using personal information. In some implementations, the client interface 130 may comprise a plurality of user interfaces that may be navigated via interactive icons, wherein interaction with these icons may present the client with another interface.

In some aspects, the client interface 130 may comprise images of local establishments. In some implementations, the images may be predetermined by each associated establishment. In some aspects, an establishment may comprise a secure connection. In some embodiments, the establishment's secure connection may comprise an account that contains identifying information of the establishment. In some embodiments, the client interface 130 may comprise a menu icon, whereby interaction with the menu icon may display the full menu of an establishment. In some aspects, the menu may display specials, full drink menus, food options, and any other non-limiting examples.

In some implementations, the client interface 130 may use geolocation to at least partially determine establishments within a certain distance of a client to present to the client for selection. In some aspects, a client may manually input or select a geographical area or physical location and, optionally, a corresponding distance or range to find establishments near them to be presented for selection. In some embodiments, geolocation data may not be saved within the client interface 130. In some aspects, the remote transaction service may utilize temporary geolocation tracking to maintain a client's anonymous identification.

In some implementations, a client may choose to maintain active monitoring of their geolocation within the client interface 130. In some aspects, the client interface 130 may comprise a secure connection, wherein the client may utilize anonymous identification. In some implementations, the client interface 130 may comprise client reviews that may be displayed within the client interface 130. In some embodiments, the use of anonymous identification may facilitate an anonymous aspect for client reviews within the client interface 130.

In some aspects, the client interface 130 may comprise a notification system, wherein clients connected to an establishment may receive updates. In some embodiments, the notification system may notify clients who frequently access establishments via the remote transaction system about establishment specials, holidays, hour changes, and other non-limiting examples. In some implementations, the client interface 130 may comprise an option to maintain a secure connection with an establishment after the client leaves the establishment. In some aspects, maintaining a secure connection for a client who visits an establishment with regular frequency may involve the storage of a unique ID within the database of the establishment and a paired external client device, such as, by way of example and not limitation, a computing device. The unique ID may allow the client to retain anonymous identification while providing an opportunity for the client to build a rapport with an establishment through frequent attendance.

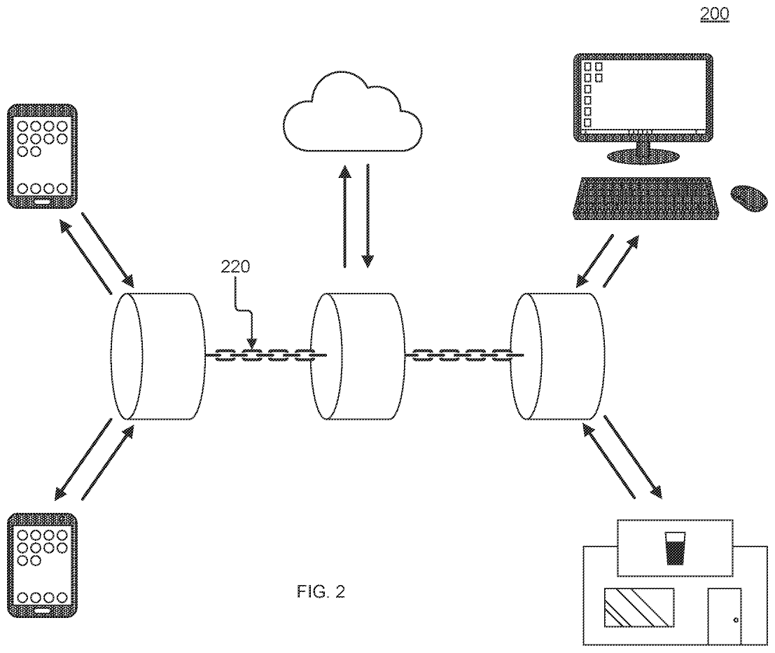

Referring now to FIG. 2, an exemplary remote transaction service 200 is illustrated. In some embodiments, the remote transaction service 200 may comprise at least one secure connection 220. In some aspects, the secure connection 220 may comprise at least one storage device, such as, by way of example and not limitation, at least one cloud storage device. In some implementations, the at least one storage device may store establishment information and associated employee information. In some aspects, the at least one storage device may comprise one or more databases that may comprise information pertaining to establishments and provide anonymous identification for clients that interact with the establishments through a unique ID. In some embodiments, the unique ID may comprise a grouping of one or more temporary randomly generated characters or variables that expires in a predetermined amount of time.

In some implementations, the secure connection 220 may comprise one or more access protocols and associated information stored within one or more storage databases associated with at least one network and used to establish the secure connection 220. In some aspects, the one or more access protocols may provide a predetermined number of unique IDs to each establishment. In some embodiments, each unique ID may become associated with a client upon request for a connection with the establishment. In some aspects, a different unique ID may be randomly generated each time a client requests an order. In some implementations, the one or more access protocols may comprise a connection that allows the one or more access protocols to provide access for the secure connection 220 to connect to at least one network, wherein the connection is configured to allow for the functioning of the remote transaction service 200 and the performance of various method steps associated therewith.

In some embodiments, a unique ID may be attached to a client for the duration of the client's stay at an establish, which may be disconnected or otherwise voided when the secure connection 220 is lost or terminated after a predefined amount of time lapses, as non-limiting examples. In some aspects, the unique ID may remain attached to the client and the establishment for repeated visits. In some implementations, the unique ID may become the identifying attribute that associates a client with an order within an establishment. In some aspects, the secure connection 220 may comprise the unique ID and preserve anonymous identification for the client.

In some aspects, the secure connection 220 may allow for one or more external devices, such as, by way of example and not limitation, one or more computing devices, to be connected to at least one singular network that comprises at least one server and at least one storage database. By way of example and not limitation, the network may comprise a cloud network. In some embodiments, a plurality of external devices may comprise devices that belong to a plurality of clients and employees, as non-limiting options. In some implementations, the remote transaction service 200 may provide a secure connection 220 between external devices associated with one or more clients. In some aspects, the clients may interact with each other via the remote transaction service 200. As an example, one patron at an establishment such as a coffee shop may buy another patron a coffee. In some embodiments, clients and employees may interact via the remote transaction service 200. In some implementations, clients and employees may verify an order jointly via the remote transaction service 200.

As an illustrative example, a client may purchase an order via the remote transaction service 200 that subsequently populates in an employee's interface. Upon completion of the order, the employee may mark the order as complete, which notifies the client that the order is in delivery. As the employee delivers the order to the client, the employee may verify the order is delivered to the correct client via a shared authentication between the client and employee interfaces such as a matching color associated with the unique ID of the order. The secure connection 220 of an interaction between one or more clients may provide the client with a method of anonymous identification.

In some aspects, the remote transaction service 200 may comprise a login system, wherein employees and administrative personnel may be required to login. In some implementations, the secure connection 220 may be joined with anonymous identification for the client. In some implementations, the secure connection 220 may comprise at least one network, including, in some non-limiting exemplary embodiments, a cloud network, wherein one or more external devices, such as, by way of example and not limitation, one or more computing devices, may be connected to an establishment's specific remote transaction service 200 interface. In some embodiments, the secure connection 220 may require the consent of the external devices to interact. In some implementations, the secure connection 220 may be established via one or more unique randomly generated characters or variables that retain anonymous identification.

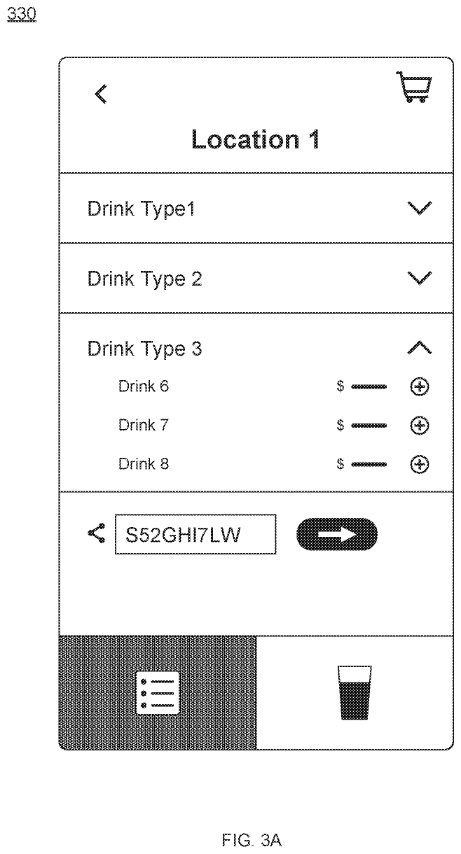

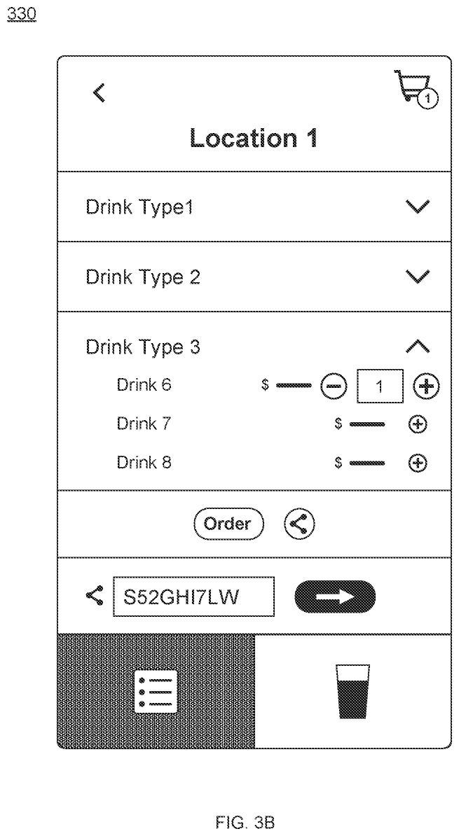

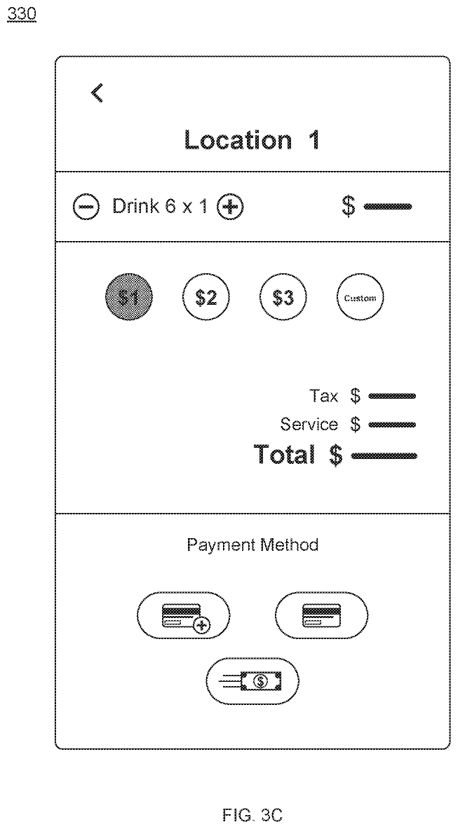

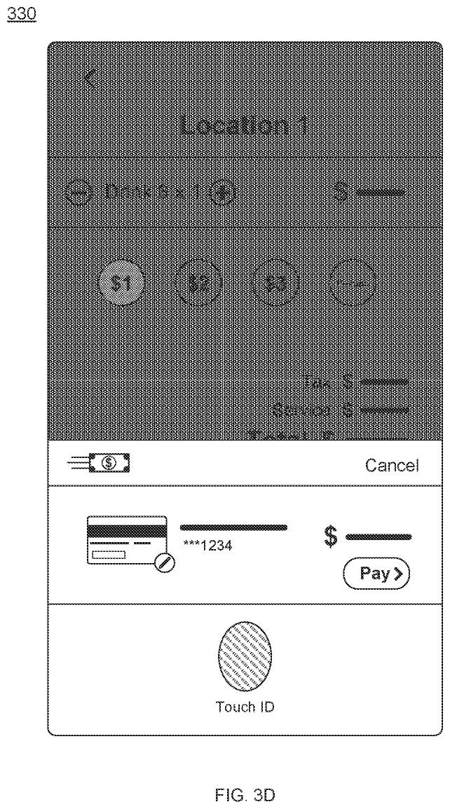

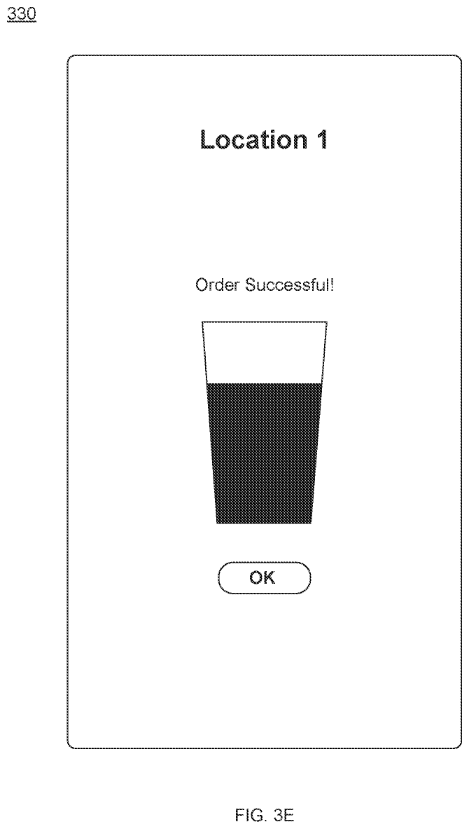

Referring now to FIG. 3A-E, an exemplary client interface 330 is illustrated. In some embodiments, the client interface 330 may comprise an ordering display. In some implementations, the client interface 330 may comprise a payment system. In some aspects, the client interface 330 may comprise an order confirmation display. In some embodiments, the client interface 330 may comprise a color coordination system.

In some embodiments, the client interface 330 may comprise an ordering display, wherein a client may select their preferred order. In some implementations, the ordering display may display prices for individual items on a menu. In some aspects, the client interface 330 may comprise a quantity selection mechanism, wherein a client may select the exact number of a particular item they wish to purchase.

For example, a client may determine they want to purchase three of the same beverage and add that number to their order using the quantity selection mechanism. In some embodiments, the client interface 330 may comprise a sharing option, wherein a unique code may be provided that is shareable between two or more clients, thereby allowing the clients to share an order. In some aspects, the unique code may comprise a unique token stored within the establishment's database that allows the code to be associated with an order request while retaining anonymous identification for the client by providing the requested service without identifying information. In some embodiments, the unique code may allow a client to share an order with another client.

In some implementations, a client may be required to select an area, table, or any other non-limiting example they wish to share an order with. In some aspects, a client who the order was shared with may be required to accept the order before the order is processed. In some implementations, the client sending the order may share the order with the receiving client via a unique ID generated and shared with the receiving client.

In some embodiments, the client interface 330 may comprise a gratuity display after completing the order. In some implementations, the gratuity display may comprise auto-generated gratuity numbers or amounts, whereby a client may select a singular number or amount. In some aspects, a client may input a manually generated gratuity number or amount. In some implementations, gratuity may be associated with the purchasing information related to a current transaction. This association may provide for the retention of anonymous identification as the transaction information may be associated with the temporary unique ID provided by the remote transaction service.

In some embodiments, the client interface 330 may comprise one or more icons, wherein a client may select how they wish to compensate their order transaction. In some aspects, the client interface 330 may comprise a transaction system, wherein the client may enter their payment method. In some implementations, the client interface 330 may allow a transaction to be divided amongst multiple clients. In some embodiments, one or more clients may input the same unique code, thereby allowing the transaction to be split. In some implementations, two or more clients may retain anonymous identification by sharing the same unique code for a split transaction.

For example, one or more clients sitting at the same table may input their unique ID into the client interface 330 and select the amount they wish to contribute to the transaction. In some embodiments, the client interface 330 may retain an existing payment method if the client chooses. In some implementations, the client interface 330 may discard payment methods after each transaction. In some aspects, the client interface 330 may request access to external payment methods within the device being used to make the transaction.

For example, if a client has a payment method linked to their external device, the client interface 330 may request to access information pertaining to that payment method, per the client's consent. In some embodiments, the client interface 330 may notify a client once their order has been processed. In some implementations, the client interface 330 may comprise geolocation information, a unique ID, one or more randomly generated characters or variables, and other non-personal identifying characteristics.

In some aspects, the client interface 330 may comprise a purchase history section, wherein a client may view their past and present orders. These orders may be accessible to clients who request the retention of their unique ID upon completion of a use of the remote transaction service. This form of history and information retention may allow the client to retain an anonymous identification while enjoying the benefits of a retained purchase history.

In some embodiments, the client interface 330 may comprise additional information pertaining to each order, wherein a client may review their order cost, tips, order details, attending employee, and other non-limiting examples. In some implementations, the client interface 330 may comprise an icon that enables a client to request to cancel an order. In some aspects, a client may cancel their order using their generated unique ID.

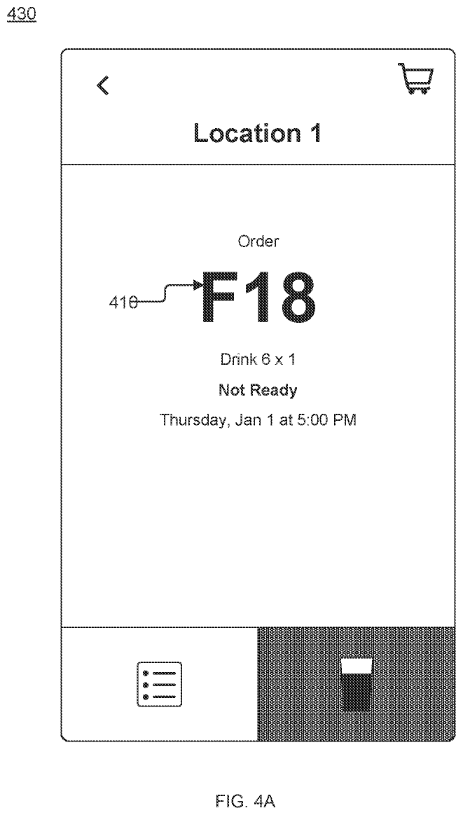

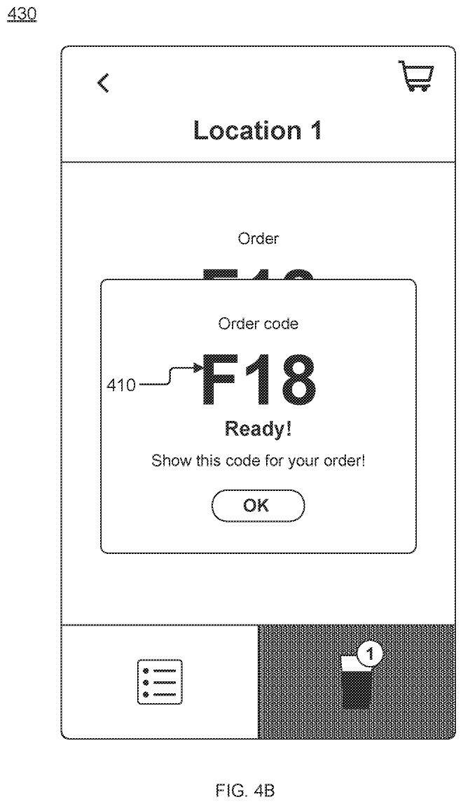

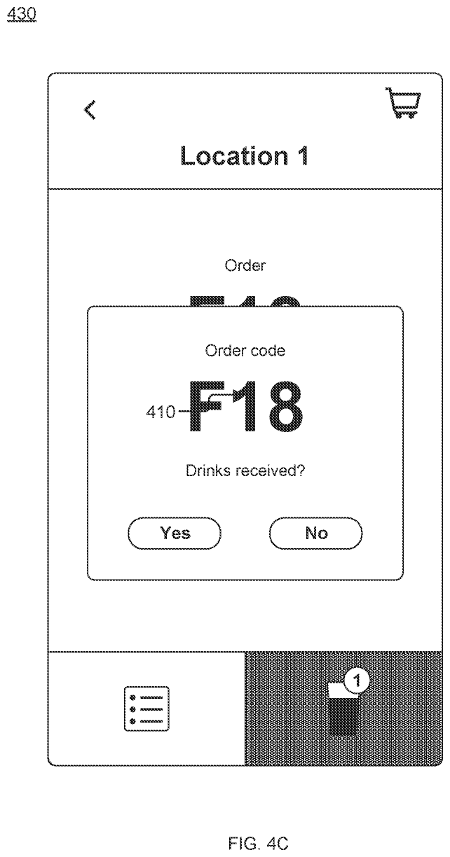

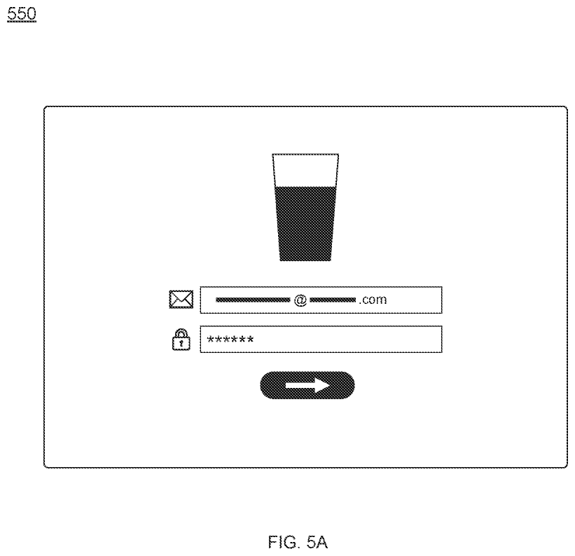

Referring now to FIGS. 4A-D, an exemplary client interface 430 is illustrated. In some aspects, the client interface 430 may comprise an order display. In some embodiments, the client interface 430 may comprise at least one unique ID 410. In some aspects, the unique ID 410 may comprise a unique hue of color. In some implementations, the hue of color may be unique to an order and serve as a visual distinction of the order for verification by an employee delivering the order to a client.

In some aspects, the visual distinction of an order may comprise one or more additional connotations for an establishment. As an example, a client may purchase an expedited order. The expedited order may comprise a unique color and a notification that comprises instructions on how to receive the expedited order. In some embodiments, these connotations or unique IDs may serve different purposes, such as allowing a client to receive priority service or enter an establishment faster than other patrons.

In some aspects, the client interface 430 may comprise one or more confirmation displays. In some embodiments, the confirmation displays may allow the client to indicate that the order has been received in addition to an indication by the employee that the order is complete. In some implementations, the confirmation displays may allow the employees to identify incorrect orders with anonymous identification for the clients.

In some embodiments, the client interface 430 may comprise a unique ID 410, wherein a grouping of one or more randomly generated characters or variables identifies a client's order. In some aspects, the unique ID 410 may be randomly generated to keep every order separate. In some implementations, the unique ID 410 may be shared with both the client and the employee handling the transaction. In some aspects, the unique ID 410 may comprise a plurality of randomly generated unique characters or variables.

For example, the remote transaction service may generate a unique character set for each individual order, combined with a unique color-scheme to simplify visual pairing. As a non-limiting example, the character set may consist of a single randomly-selected letter attached to a running order count for the day's orders to ensure uniqueness. In some embodiments, the client may receive their unique ID 410 after completing a transaction, such as when an order is placed, as a non-limiting example. In some implementations, the client interface 430 may comprise a confirmation display, wherein a client confirms their order has been delivered. In some aspects, once the client has confirmed delivery of their order, the client interface 430 may notify an employee. In some embodiments, the order may be moved to a completed section within the client interface 430.

For example, the client may suggest they have not received their order through the client interface 430, and an employee may be alerted through a notification to complete this order. In some embodiments, the client interface 430 may comprise a notification system, wherein the client receives updates about their orders. In some aspects, the notification system may utilize the unique ID 410 to establish a secure connection between the client and the establishment. In some embodiments, the unique ID 410 and the secure connection may maintain anonymous identification for the client while simultaneously establishing a unique and individual connection. In some implementations, the client interface 430 may comprise color coordination when generating a unique ID 410 to further distinguish each unique ID 410.

In some implementations, the client interface 430 may notify an employee if a client has denied receiving their order. In some aspects, the client interface 430 may comprise an icon, wherein the icon notifies employees of clients that have yet to receive their order. In some embodiments, the client interface 430 may comprise a menu, wherein a client may check the status update of their order. In some implementations, a client may use unique ID 410 to receive an order status update, rather than inputting personal information.

In some aspects, multiple unique IDs 410 may comprise the same hue of color. For example, all unique IDs that start with the letter “B” may comprise a blue hue. As another nom-limiting example, all unique IDs 410 that end with two numerical characters may correspond to the color orange. In some embodiments, the color of the unique ID 410 may be directly related to the section the associated client(s) reside in at an establishment. In some implementations, the client interface 430 may record a client's seat number in an establishment, rather than note their personal information.

In some aspects, the unique ID 410 may be secured on an external device within a secure connection. In some embodiments, the client interface 430 may associate each unique ID 410 with the corresponding external device. In some implementations, a client may purchase an item for another client in a separate physical location. In some aspects, a client may use their unique ID 410 to find their order at a defined pick up area in the establishment.

For example, one client may be at home in Utah and purchase an item for another client in Florida through the client interface 430. In some embodiments, both clients may receive the same confirmation of the unique ID 410. In some implementations, if an order is being shared, each external device may receive the same unique ID 410 on their client interface 430.

In some embodiments, a unique ID 410 may be used to gain entry to a venue by showing proof-of-purchase to the location's entry manager, such as a doorman or “bouncer”. A user may receive a unique ID 410 as confirmation that they can enter an establishment after paying for the venue's cover charge, purchasing a quick-entry “fast pass” for expedited entry to the venue, or purchasing a menu item, as non-limiting examples. The patron may then use the purchase-associated unique ID 410 to indicate to a gatekeeper that they are authorized to enter.

In some embodiments, a unique ID 410 may be associated with a table or other area of an establishment. A patron, or group of patrons, may receive a unique ID 410 as confirmation that they have exclusive rights to use an area for a specified period of time as the result of a purchase, such as, for example, after paying to reserve a table.

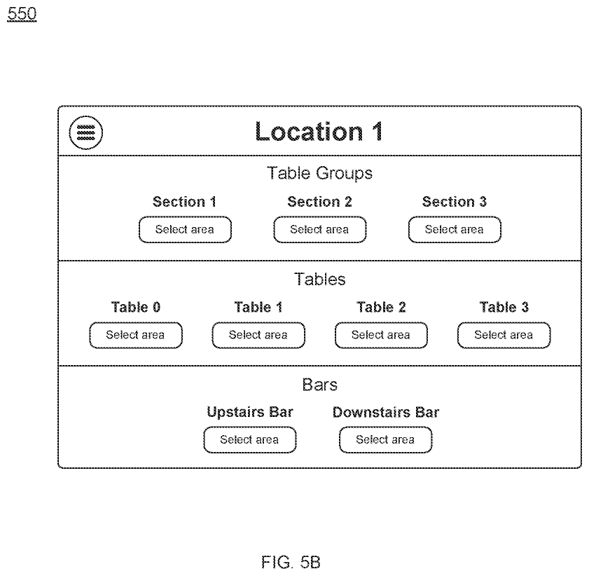

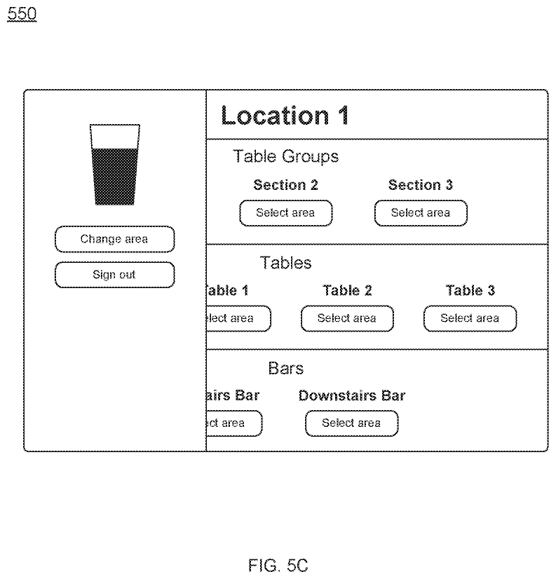

Referring now to FIG. 5A-C an exemplary employee interface 550 is illustrated. In some aspects, the employee interface 550 may comprise a login display. In some embodiments, the employee interface 550 may be connected to a secure connection. In some implementations, the login display may comprise a manually generated email, username, or password, as non-limiting components, that may be input to access the interface 550.

In some aspects, the employee interface 550 may comprise an establishment mapping system, wherein an employee may select the area they are working in. In some implementations, the establishment mapping system may comprise a plurality of associated unique characters or variables that establish a connection with the unique IDs of the clients in a predetermined region of the establishment. The pairing of unique IDs may allow the clients to accurately direct an order to the present location of the client while maintaining anonymous identification.

In some embodiments, the employee interface 550 may comprise a navigational menu, whereby an employee may change the region they are working in. In some implementations, the employee interface 550 may comprise access to the orders in a predetermined region. In some aspects, employees may comprise a unique ID that becomes associated with a predetermined region. In some embodiments, the association of the employee with their respective predetermined region may allow the remote transaction service to notate which employees are in which regions of the establishment for management purposes, as a non-limiting example.

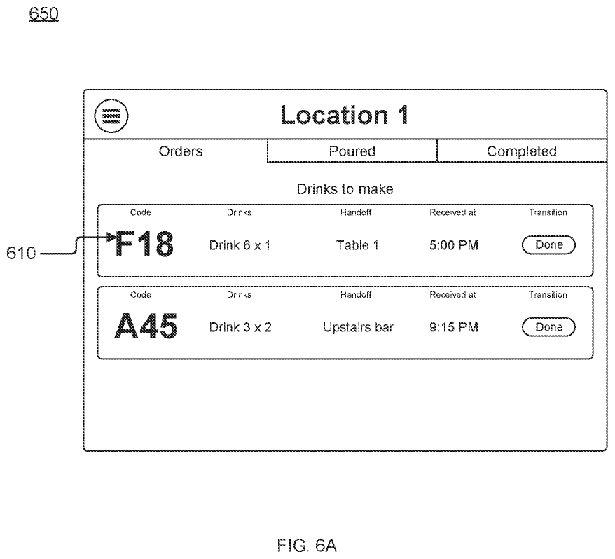

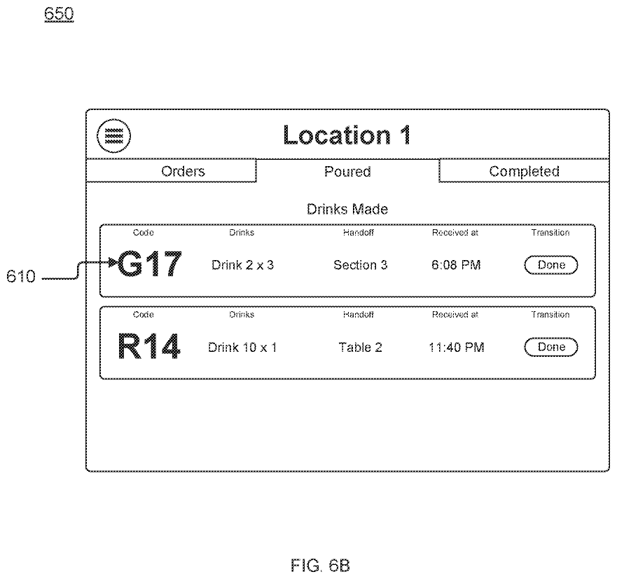

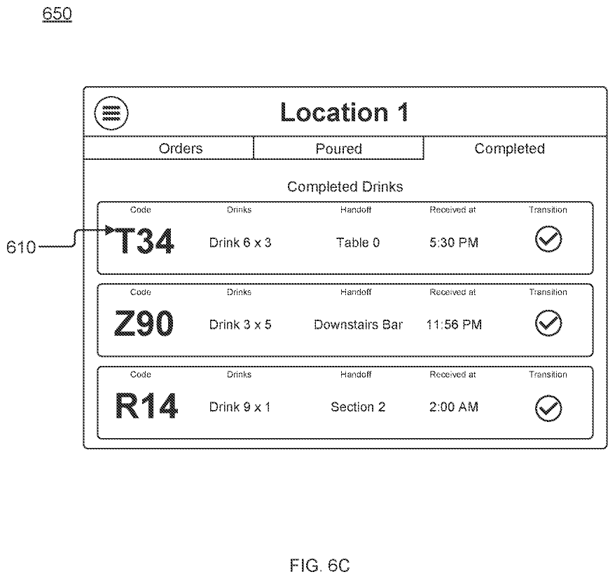

Referring now to FIG. 6A-C an exemplary employee interface 650 is illustrated. In some aspects, the employee interface 650 may comprise a transaction menu. In some embodiments, the employee interface 650 may comprise a color coordination system. In some implementations, an employee may use color coordination to match orders with the corresponding color of the unique ID of the client. In some aspects, the color coordination system may comprise a map, wherein the employee may be directed to the section where the client is located while using the client's anonymous identification.

In some implementations, the employee interface 650 may comprise one or more unique IDs 610. In some aspects, the transaction menu may comprise an order status, wherein an employee may utilize a unique ID 610 to view where an order is in the order fulfillment process. In some implementations, the order status may be altered by an employee via an order status update. In some embodiments, the employee interface 650 may comprise a color coordination system, wherein an employee is aware of the order status update because of its color.

For example, a unique ID 610 surrounded with red may indicate that the order has not been fulfilled by an employee. In some implementations, the employee interface 650 may comprise a notification system, wherein an employee is notified of an order and where it resides in the order fulfillment process. In some aspects, the employee interface 650 may comprise one or more menus, wherein orders reside based on their time ordered, completion status, cancellation status, and other non-limiting factors.

For example, one section of the remote transaction service may comprise new orders, while another area may comprise orders that have been completed. In some embodiments, the employee interface 650 may comprise one or more icons, wherein an employee may view various details related to an order, such as, but not limited to, item quantity, gratuity amount, or fulfillment status. In some aspects, the employee interface 650 may allow the employee to move orders from one area to another by signifying a transition in the status of an order, such as the completion of an order, as a non-limiting example. In some implementations, the employee interface 650 may comprise one or more interaction icons, wherein an employee may interact with a client through a live chat related to a unique ID 610.

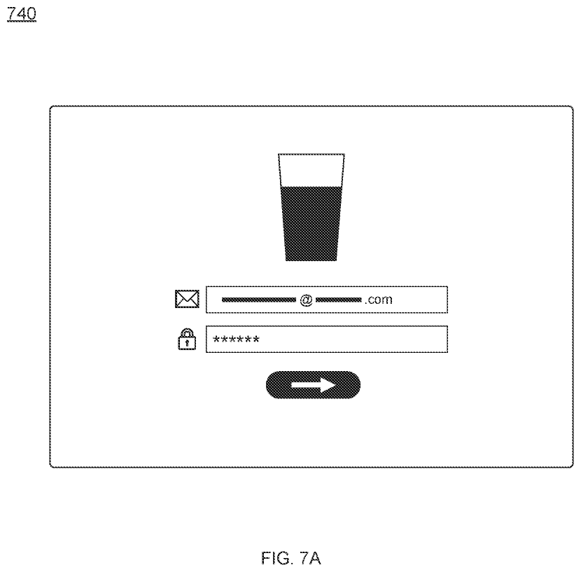

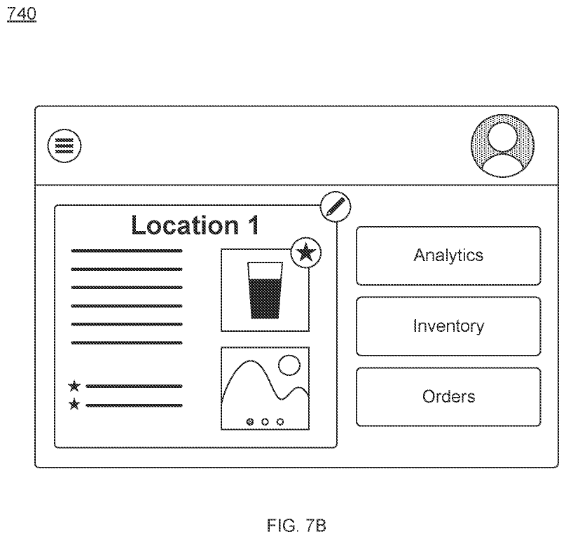

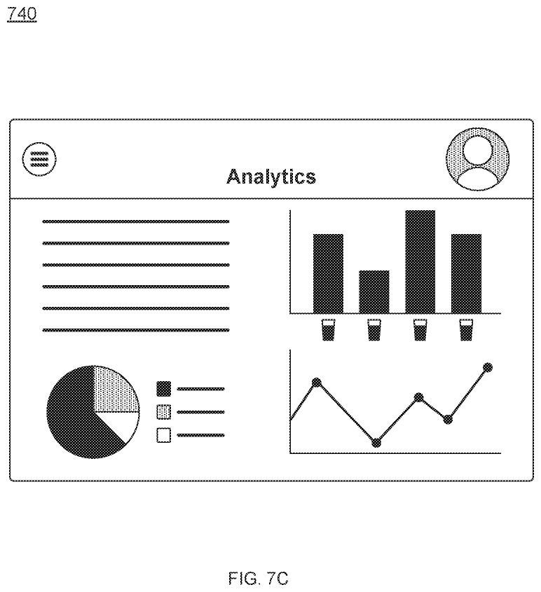

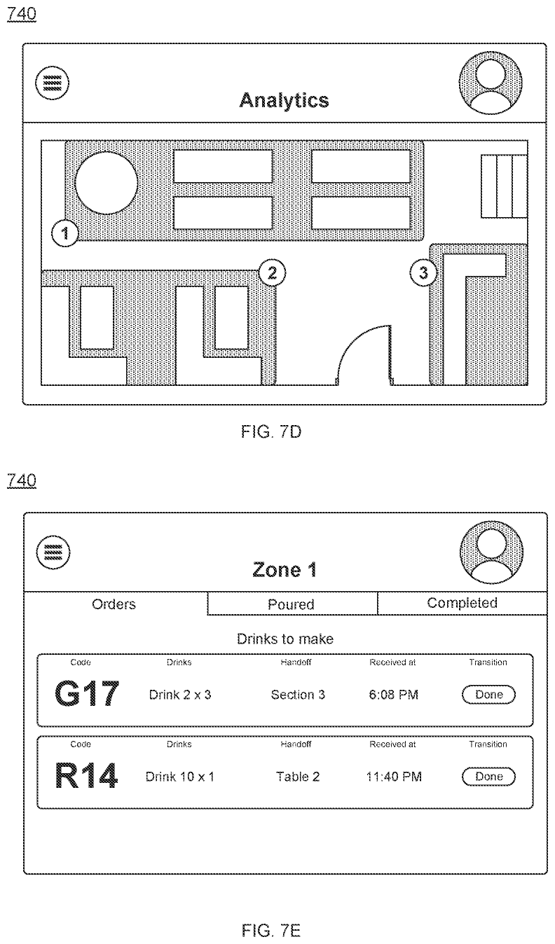

Referring now to FIG. 7A-B an exemplary administrative interface 740 is illustrated. In some aspects, the administrative interface 740 may comprise a login display, wherein identifying information may be input to access the interface 740. In some embodiments, the administrative interface 740 may allow direct communication with employees. However, clients may only communicate by using their unique ID to maintain anonymous identification.

In some embodiments, the administrative interface 740 may comprise an overview menu, wherein an administrator may access analytics, inventory, orders, and other non-limiting examples through the interface 740. In some implementations, the administrative interface 740 may comprise one or more interactive icons, wherein an administrator may access and alter various establishment details.

For example, an administrator may use an interactive icon to modify weekly specials regarding their establishment through the administrative interface 740. In some aspects, the administrative interface 740 may comprise an automation system, wherein underperforming products may no longer be promoted, products may be ordered, and other non-limiting examples. In some embodiments, the administrative interface 740 may comprise automation that may update menu prices, remove out-of-stock items from the current menu, and promote items using machine learning. For example, “trending” items may be promoted to enable batched order fulfillment.

In some aspects, machine learning may comprise data analytics and predictive models based on purchase history, as non-limiting examples. In some embodiments, the automated remote transaction service may use existing unique IDs within the establishment as its predefined target audience for receiving information and promoting establishment merchandise. In some implementations, the administrative interface 740 may comprise a maintenance system, wherein an administrator may put in work orders, request renovation, and other non-limiting examples.

In some aspects, the administrative interface 740 may comprise a secure connection, wherein passwords, personal information, identifying information, and other non-limiting examples remain private. In some embodiments, the administrative interface 740 may comprise an overview of the establishment mapping system, wherein an administrator may view order fulfillment statuses for the establishment.

Referring now to FIG. 7C an exemplary administrative interface 740 is illustrated. In some aspects, the administrative interface 740 may comprise an analytics menu. In some embodiments, the analytics menu may comprise statistical data regarding an establishment. In some implementations, the analytics menu may comprise information regarding transactions. In some aspects, the analytics page may comprise data regarding what items sell the most and may propose suggestions for business model changes, such as the non-limiting examples of menu and promotional changes, based on transaction history collected by unique ID related transactions.

In some embodiments, the analytics menu may comprise reports regarding client traffic. In some implementations, the analytics menu may comprise employee notes, wherein an administrator may respond. In some aspects, the administrative interface 740 may comprise interactive charts on the analytics menu, wherein an administrator may view details regarding specific analytics. In some embodiments, the administrative interface 740 may comprise a machine learning system, wherein analytics may be used to push products based on current purchase trends within the establishment.

Referring now to FIG. 7D-E, an exemplary administrative interface 740 is illustrated. In some aspects, the administrative interface 740 may comprise a physical map of an establishment. In some embodiments, the physical map may provide details regarding the establishment including, but not limited to, sections within the establishment and their associated employees, orders, and order details. In some implementations, clients' information may be displayed using unique IDs to retain anonymous identification.

In some aspects, the administrative interface 740 may comprise a section map, wherein an administrator may access each section of the establishment. In some embodiments, the section map may comprise a physical layout of the establishment, which may include options to select specific tables and booths, as non-limiting options. In some implementations, the section map may be interactive, wherein an administrator may view orders from a specific section.

For example, an administrator may interact with the bar section of an establishment, and then the administrative interface 740 may display the orders from that section. In some aspects, the administrative interface 740 may comprise a plurality of ordering sections, wherein an administrator may view completed, unprocessed, or other non-limiting examples of order statuses. In some embodiments, the administrative interface 740 may comprise an order management system, wherein orders may be deleted from the system, prices may be adjusted, and other non-limiting examples. In some implementations, the administrator may interface with the orders of clients via the clients' unique IDs to maintain the clients' anonymous identification.

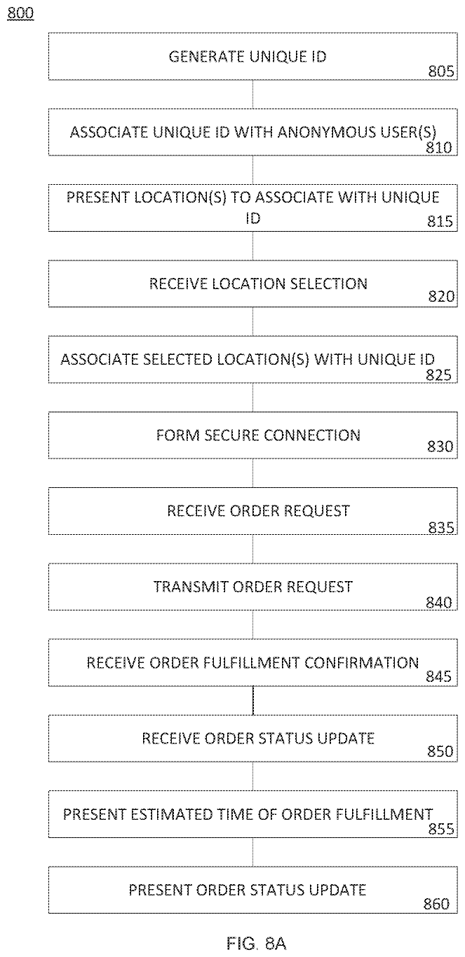

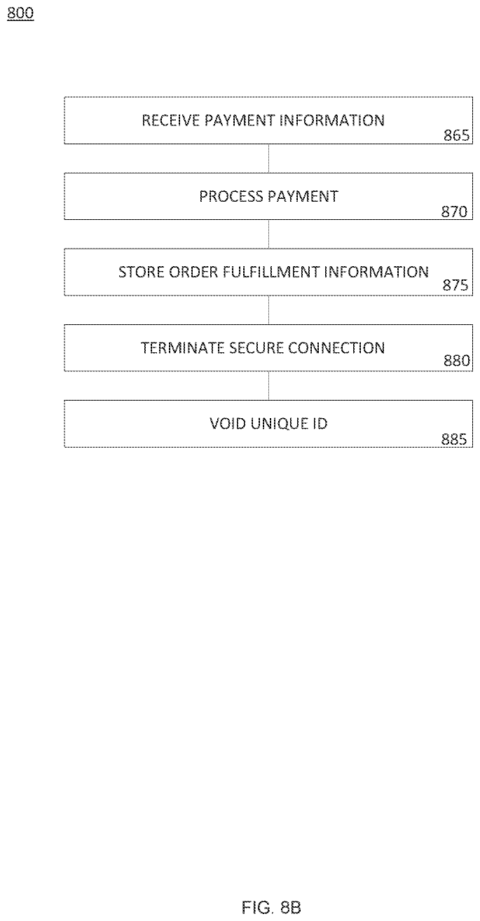

Referring now to FIGS. 8A-B, exemplary method steps for providing a remote transaction service are illustrated. At 805, the remote transaction service may generate at least one unique ID. At 810, the remote transaction service may associate the at least one unique ID with at least one anonymous user. At 815, the remote transaction service may present at least one location to associate with the at least one unique ID to the at least one anonymous user.

At 820, the remote transaction service may receive a selection of the at least one location to associate with the at least one unique ID from the at least one anonymous user. At 825, the remote transaction service may associate the selected at least one location with the at least one unique ID. At 830, the remote transaction service may form at least one secure connection between at least one server, at least one computing device associated with the least one location and at least one computing device associated with at the at least one anonymous user.

At 835, the remote transaction service may receive a request for at least one order from the at least one anonymous user, wherein the at least one order comprises a product or service provided by the at least one location. At 840, the remote transaction service may transmit the request for the at least one order to the at least one location. At 845, the remote transaction service may receive confirmation of order fulfillment from the at least one anonymous user. In some embodiments, at 850, the remote transaction service may receive at least one order status update from at least one employee of the at least one location.

In some aspects, at 855, the remote transaction service may present an estimated time of fulfillment for the at least order received from the at least one anonymous user. In some implementations, at 860, the remote transaction service may present the at least one order status update to the at least one anonymous user. In some embodiments, at 865, the remote transaction service may receive electronic payment information for the at least one order from the at least one anonymous user. In some aspects, at 870, the remote transaction service may process payment for the at least one order using the electronic payment information received from the at least one anonymous user. In some implementations, at 875, the remote transaction service may store information pertaining to the order fulfillment (e.g., products or services ordered, time required to fulfill order, employee(s) involved in order fulfillment, etc.) in at least one database associated with the at least one location or the at least one anonymous user.

In some embodiments, at 880, the remote transaction service may terminate the at least one secure connection between the at least one server, the at least one computing device associated with the at least one location and the at least one computing device associated with the at least one anonymous user. In some implementations, the at least one secure connection may be automatically terminated by the remote transaction service after a predetermined amount of time lapses or after the remote transaction service determines, such as, by way of example and not limitation, via geolocation, that the at least one user is no longer physically present at the at least one location. In some aspects, at 885, remote transaction service may void the at least one unique ID. In some embodiments, the at least one unique ID may become voided automatically when the at least one secure connection is terminated.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A computer-implemented method for providing a remote transaction service, the computer-implemented method comprising:
generating at least one unique identifier;
associating the at least one unique identifier with at least one anonymous user;
presenting at least one location to associate with the at least one unique identifier;
receiving a selection of the at least one location to associate with the at least one unique identifier;
associating the selected at least one location with the at least one unique identifier;
forming at least one secure connection between at least one server, at least one computing device associated with the at least one location, and at least one computing device associated with the at least one anonymous user;
receiving a request for at least one order from the at least one anonymous user, wherein the at least one order comprises a product or service provided by the at least one location;
transmitting the request for the at least one order to the at least one location; and
receiving confirmation of order fulfillment from the at least one anonymous user.

2. The method of claim 1, further comprising:
receiving electronic payment information for the at least one order from the at least one anonymous user; and
processing payment for the at least one order using the electronic payment information received from the at least one anonymous user.

3. The method of claim 1, further comprising:
storing information pertaining to the order fulfillment in at least one database.

4. The method of claim 1, wherein the presentation of the at least one location to the at least one anonymous user selection is at least partially determined by geolocation.

5. The method of claim 1, wherein the presentation of the at least one location to the at least one anonymous user selection is at least partially determined by a selection of a geographical area.

6. The method of claim 1, wherein the at least one unique identifier at least partially comprises a color.

7. The method of claim 1, wherein the at least one unique identifier is shareable between two or more anonymous users.

8. The method of claim 1, further comprising:
presenting an estimated time of fulfillment for the at least one order received from the at least one anonymous user.

9. The method of claim 1, wherein the at least one anonymous user is not physically present at the at least one location.

10. The method of claim 1, further comprising:
terminating the at least one secure connection between the at least one server, the at least one computing device associated with the at least one location and the at least one computing device associated with the at least one anonymous user.

11. The method of claim 10, wherein the at least one unique identifier becomes void after the at least one secure connection between the at least one location and the anonymous user is terminated.

12. The method of claim 10, wherein the at least one unique identifier is automatically terminated after a predetermined amount of time lapses.

13. The method of claim 1, wherein the at least one secure connection comprises one or more access protocols.

14. A system for providing a remote transaction service, comprising:
one or more computing devices;
at least one secure connection, wherein the at least one secure connection connects to the one or more computing devices;
at least one server, wherein the at least one secure connection connects the at least one server to the one or more computing devices;
at least one storage database, wherein the at least one storage database comprises one or more access protocols and associated information for establishing the at least one secure connection between the one or more computing devices and the at least one server;
at least one network, wherein the at least one network comprises the at least one server and the at least one storage database;
wherein the one or more access protocols comprise:
a connection, wherein the connection allows the one or more access protocols to provide access for the at least one secure connection to connect to the at least one network, wherein the connection is configured to enable the system to:
generate at least one unique identifier;
associate the at least one unique identifier with at least one anonymous user;
present at least one location to associate with the at least one unique identifier;
receive a selection of the at least one location to associate with the at least one unique identifier;
associate the selected at least one location with the at least one unique identifier;
form the at least one secure connection between the at least one server, at least one computing device associated with the at least one location, and at least one computing device associated with the at least one anonymous user;
receive a request for at least one order from the at least one anonymous user, wherein the at least one order comprises a product or service provided by the at least one location;
transmit the request for the at least one order to the at least one location; and
receive confirmation of order fulfillment from the at least one anonymous user.

15. The system of claim 14, wherein the at least one network comprises a cloud network.

16. The system of claim 14, wherein the at least one storage database comprises cloud storage.

17. The system of claim 14, wherein the connection is further configured to enable the system to:
receive electronic payment information for the at least one order from the at least one anonymous user;
process payment for the at least one order using the electronic payment information received from the at least one anonymous user;
store information pertaining to the order fulfillment in the at least one storage database; and
terminate the at least one secure connection between the at least one server, the at least one computing device associated with the at least one location and the at least one computing device associated with the at least one anonymous user.

18. The system of claim 17, wherein the at least one unique identifier is voided when the at least one secure connection between the at least one location and the at least one anonymous user is terminated.

19. The system of claim 17, wherein the at least one secure connection is automatically terminated after a predetermined amount of time lapses.

20. The system of claim 14, wherein the at least one unique identifier comprises one or more unique random variables.
